(19) United States
(12) Patent Application Publication
(10) Pub. No.: US 2024/0107598 A1
(43) Pub. Date: Mar. 28, 2024

(54) STORAGE MEDIUM, INFORMATION PROCESSING APPARATUS, AND CONTROL METHOD FOR THE INFORMATION PROCESSING APPARATUS

(71) Applicant: CANON KABUSHIKI KAISHA, Tokyo (JP)

(72) Inventor: AKIRA NAKAMURA, Tokyo (JP)

(21) Appl. No.: 18/469,939

(22) Filed: Sep. 19, 2023

(30) Foreign Application Priority Data
Sep. 22, 2022 (JP) 2022-151312

(51) Int. Cl. H04W 76/10

(52) U.S. Cl. CPC H04W 76/10

(57) ABSTRACT

A non-transitory computer-readable storage medium storing computer-executable instructions that, when executed by a computer of an information processing apparatus, cause the computer of the information processing apparatus to perform operations that include communicably connecting to a communication apparatus, acquiring a wireless connection capability of the communication apparatus from the communication apparatus as a first acquisition, changing a setting for tethering connection of the information processing apparatus so as to match the wireless connection capability as a first setting, and transmitting information including the setting for tethering connection to the communication apparatus.

### BACKGROUND

### Field of the Disclosure

The present disclosure relates to a storage medium, an information processing apparatus and a control method for the information processing apparatus.

### Description of the Related Art

Web services using the Internet have been in widespread use. Among such Web services, for example, there are automatic consumables ordering systems in which a printer notifies a Web server of remaining amounts of consumables, such as ink, toner, and sheets, and the Web server automatically orders a consumable item from a supplier office based on the information on the remaining amount of the consumable item. In addition, there have appeared flat-sum Web services in which a user charters a printer for which an automatic consumables ordering system is available, and the user can get replacement consumables on a flat-sum basis together with a charge for using the printer main body.

In some flat-sum Web services, the use of a printer is restricted if the printer is not registered in the Web service. In this case, the use of a printer involves connection processing to a network and registration with the Web service. However, there are environments where users cannot connect their printers to networks, preventing registration processing, for example, in cases of no access points nearby to which a user can connect a printer subject to set up processing.

Japanese Patent No. 6389536 discusses a technique of enabling, for example, a printer to be connected to the network to which the terminal device is connected by a method via a terminal device connected to a network.

It is conceivable that using the technique of Japanese Patent No. 6389536, a user connects a printer to a network to which a terminal device is connected and registers the printer with a Web service described above.

However, there are cases where printers can be connected only to wireless local area networks (LAN) corresponding to the radio waves in a specific frequency band and where printers can be connected only to wireless LANs compliant with a specific encryption scheme, depending on the wireless connection capability of each printer. As a result, some printers are prevented from being connected to a network to which a terminal device is connected, depending on the wireless connection capability of each printer, since those printers do not support the frequency band or the encryption scheme for wireless tethering connection of the corresponding terminal device. In this case, a printer cannot be connected to a network to which a terminal device is connected.

This issue is not limited to printers, but is common to communication devices having wireless connection capabilities.

### SUMMARY

Some embodiments of the present disclosure solve the issues described above. Some embodiments of the present disclosure are directed to providing a system allowing easy setup including network connection regardless of the wireless connection capability of a communication apparatus.

According to an aspect of the present disclosure, a non-transitory computer-readable storage medium stores computer-executable instructions that, when executed by a computer of an information processing apparatus, cause the computer of the information processing apparatus to perform operations that include communicably connecting to a communication apparatus, acquiring a wireless connection capability of the communication apparatus from the communication apparatus as a first acquisition, changing a setting for tethering connection of the information processing apparatus so as to match the wireless connection capability as a first setting, and transmitting information including the setting for tethering connection to the communication apparatus.

Further features of various embodiments will become apparent from the following description of exemplary embodiments with reference to the attached drawings.

### BRIEF DESCRIPTION OF THE DRAWINGS

FIG. 1 illustrates an example of a system configuration according to a first exemplary embodiment.

FIG. 2 illustrates an example of a hardware configuration of a personal computer (PC).

FIG. 3 illustrates an example of a hardware configuration of a printer.

FIG. 4 illustrates an example of a hardware configuration of an information processing apparatus configured to constitute a management server.

FIGS. 5A and 5B are a flowchart illustrating an example of processing of a setup application according to the first exemplary embodiment.

FIGS. 6A and 6B are a flowchart illustrating an example of processing of a setup application according to a second exemplary embodiment.

### DESCRIPTION OF THE EMBODIMENTS

Embodiments of the present disclosure will now be described with reference to the accompanying drawings. Configurations described in the following exemplary embodiments are merely examples, and some embodiments of the present disclosure are not limited to the configurations illustrated. Hereinafter, a printer that prints images will be described as an example of an image processing apparatus according to each of the exemplary embodiments. A personal computer (PC) will be described as an example of an information processing apparatus that performs wireless setting processing on the image processing apparatus according to each of the present exemplary embodiments. However, these do not limit the present disclosure. The information processing apparatus may be an information processing terminal, such as a smartphone or a tablet, or the processing of the information processing apparatus according to each of the present exemplary embodiments may be applied to various types of devices, such as a digital camera.

### <System Configuration>

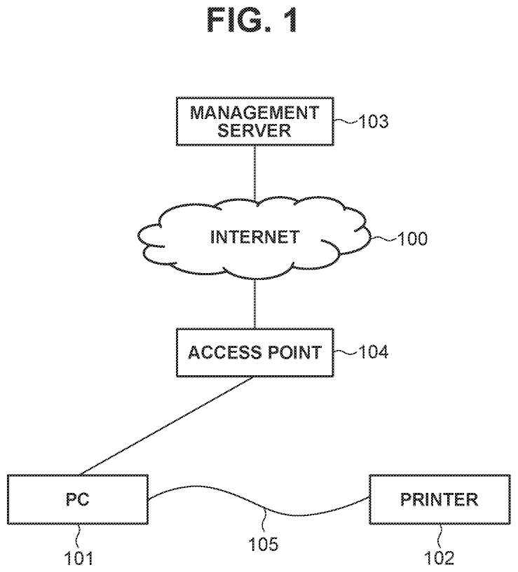

FIG. 1 illustrates an example of a system configuration according to a first exemplary embodiment of the present disclosure.

The information processing system according to the present exemplary embodiment includes a PC 101 as an information processing apparatus, a printer 102 as an image processing apparatus, and a management server 103.

The PC 101 can connect to the Internet via an access point 104. The PC 101 is not limited to a personal computer, and may be a tablet computer or a smartphone as an example.

The management server 103 is connected to the Internet 100. The management server 103 may be a single computer or may be composed of a plurality of computers. The management server 103 may be on-premise or may be configured to be implemented using a cloud computing technology.

The printer 102 is communicable with the PC 101 via a Universal Serial Bus (USB) cable 105, for example. In other words, the printer 102 is directly connectable to the PC 101, not through a network. An example of USB will be described as a direct connection interface between the printer 102 and the PC 101 in the present exemplary embodiment, but another direct connection interface between the PC 101 and the printer 102, such as Wi-Fi® Direct and short-range wireless communication (e.g., Bluetooth® Low Energy (BLE) and near-field communication (NFC)) may be used. In the following description, registered marks for Wi-Fi®, Wi-Fi® Direct, and Bluetooth® may be omitted in some cases.

The management server 103 manages information transmitted from the PC 101 and the printer 102. Each communication is controlled through a protocol, such as Hypertext Transfer Protocol (HTTP) or Extensible Messaging and Presence Protocol (XMPP).

### <Hardware Configuration of Personal Computer>

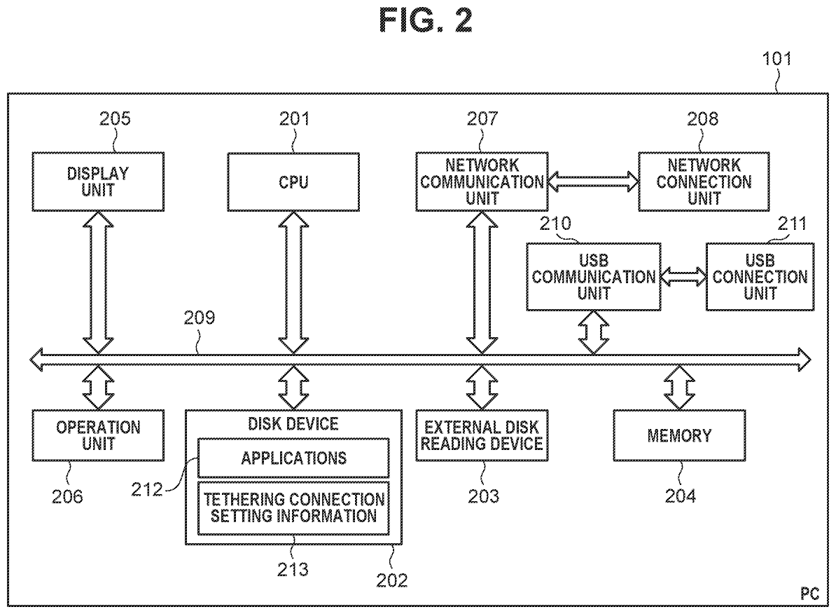

FIG. 2 illustrates an example of a hardware configuration of the PC 101.

The PC 101 includes a central processing unit (CPU) 201, a disk device 202, an external disk reading device 203, a memory 204, a display unit 205, and an operation unit 206. The PC 101 also includes a network communication unit 207, a network connection unit 208, a USB communication unit 210, and a USB connection unit 211.

The CPU 201 is a central processing unit for controlling units of the PC 101.

The disk device 202 stores various types of files, such as application programs (hereinafter referred to as “applications”) 212 read by the CPU 201, an operating system (not illustrated) (hereinafter referred to as an “OS”), and tethering connection setting information 213, which will be described below.

The external disk reading device 203 is a device for reading data, such as files stored on an external storage medium, such as an SD card.

The memory 204 is a random-access memory (RAM), for example. The CPU 201 performs temporary data storage, buffering, or other processing as appropriate.

The display unit 205 includes, for example, a liquid crystal display (LCD), and displays various types of information.

The operation unit 206 includes, for example, a keyboard and a mouse for a user to perform various input operations. Like a touch panel display, combined functions of the display unit 205 and the operation unit 206 may be provided.

The network communication unit 207 connects with the access point 104 via the network connection unit 208. In other words, the network communication unit 207 is connected to a network, such as the Internet 100, via the network connection unit 208 and performs various types of communication. The network communication unit 207 is a communication unit supporting wired local area networks (LAN) or wireless LANs. For example, if the network communication unit 207 supports wired LANs, the network connection unit 208 is a connector for connecting a cable of a wired LAN. If the network communication unit 207 supports wireless LANs, the network connection unit 208 serves as an antenna for a wireless LAN.

The USB communication unit 210 is connected to various types of peripheral devices (e.g., the printer 102) via the USB connection unit 211, and performs various communications.

The foregoing components 201 to 207, and 210 are connected to each other via a bus 209.

The tethering connection setting information 213 will now be described.

The tethering connection setting information 213 indicates connection setting information related to a tethering connection function of the PC 101. The tethering connection setting information 213 is information including identification information (e.g., service set identifier (SSID)) in tethering connection through a wireless LAN, authentication information (e.g., password) used in authentication processing at the time of tethering connection, and other types of information. The tethering connection setting information 213 is managed by the OS.

### <Hardware Configuration of Printer>

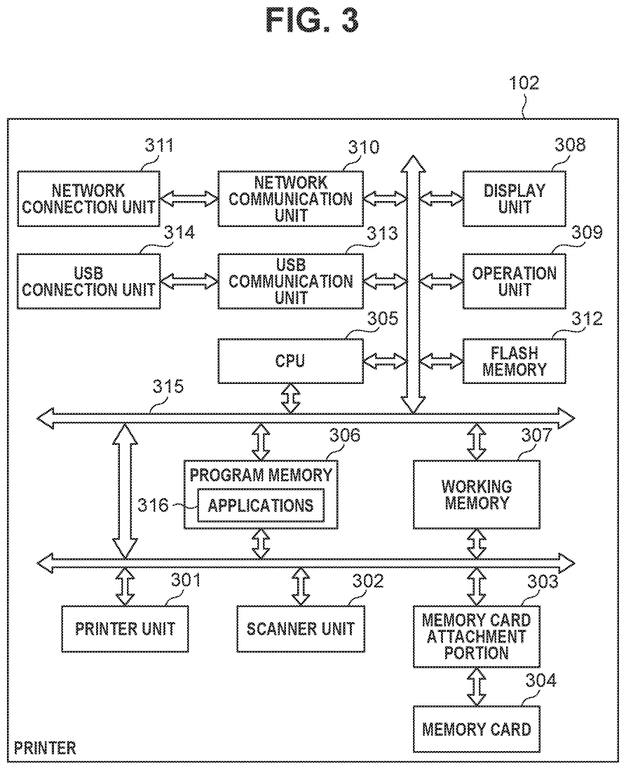

FIG. 3 illustrates an example of a hardware configuration of the printer 102.

The printer 102 includes a printer unit 301, a scanner unit 302, a memory card attachment portion 303, and a memory card 304. The printer 102 also includes a CPU 305, a program memory 306, a working memory 307, a display unit 308, an operation unit 309, a network communication unit 310, a network connection unit 311, a flash memory 312, a USB communication unit 313, and a USB connection unit 314. In the present exemplary embodiment, the printer 102, which is a multifunction peripheral, will be described as an example of the image processing apparatus. However, the image processing apparatus may be a copying machine, a facsimile machine, or another type of machine, or may be a printer without a scanner function.

In the printer 102, its print function is carried out by the printer unit 301, its scanner function is carried out by the scanner unit 302, and its storage function is carried out by the memory card attachment portion 303 and the memory card 304. The printer unit 301 prints image data received from the outside, image data stored in the memory card 304, and image data from another source on print sheets by a recording system, such as an inkjet system or an electrophotographic system. The printer unit 301 also manages printing agent information including a remaining amount of a printing agent, such as ink or toner, and sheet information including the number of stacked sheets.

The scanner unit 302 optically reads a document set on a document table (not illustrated), converts the read document into electronic data, and transmits image data converted into a specified file format to an external device via a network or stores the image data in a storage area (not illustrated), such as a hard disk drive (HDD). Copying is performed by transferring image data generated by reading a document placed on a document table by the scanner unit 302 to the printer unit 301, and printing the image data on a print sheet or print sheets by the printer unit 301.

Various types of file data are stored in the memory card 304 attached to the memory card attachment portion 303. The file data can be read and edited from an external device via a network. Further, file data can be stored in the memory card 304 from an external device.

The CPU 305 is a central processing unit for controlling units in the printer 102.

The program memory 306 is a read-only memory (ROM), for example, and stores various program codes and applications 316 for communicating with a server device. Further, the applications 316 access the printer unit 301 to acquire consumable information, such as a printing agent and a sheet.

The working memory 307 is a RAM, for example, and is used in temporarily storing or buffering image data, a job log, and other types of data during execution of each Web service.

The display unit 308 includes, for example, an LCD, and displays various types of information.

The operation unit 309 includes, for example, switches for a user to perform various input operations with.

In addition, combined functions of the display unit 308, such as a touch panel display, and the operation unit 309 may be provided.

The network communication unit 310 connects with the access point 104 via the network connection unit 311. In other words, the network communication unit 310 connects to a network, such as the Internet 100, via the network connection unit 311, and performs various communications. Each communication is controlled through a protocol, such as HTTP or XMPP. The network communication unit 310 is a communication unit supporting wired LANs or wireless LANs. If the network communication unit 310 supports wired LANs, the network connection unit 311 is a connector for connecting a cable of a wired LAN. If the network communication unit 310 supports wireless LANs, the network connection unit 311 serves as an antenna for a wireless LAN.

The flash memory 312 is a non-volatile memory for storing image data and other types of data received by the network communication unit 310.

The USB communication unit 313 is connected to various types of peripheral devices (e.g., the PC 101) via the USB connection unit 314 and performs various communications.

The foregoing units are connected to each other by a bus 315.

### <Hardware Configuration of Server>

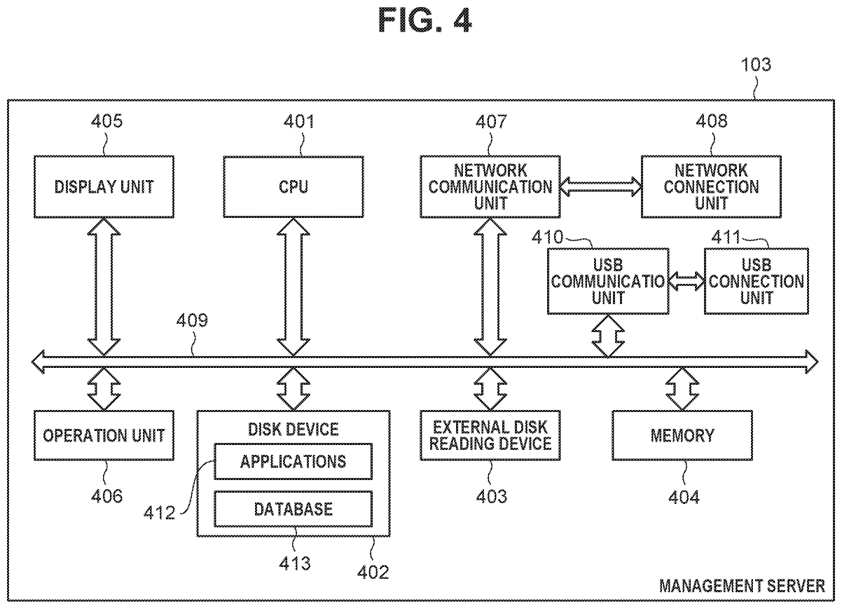

FIG. 4 is a block diagram illustrating an example of a hardware configuration of the information processing apparatus configured to constitute the management server 103. Components 401, and 403 to 411 in FIG. 4 have the same configurations as the components 201, and 203 to 211 in FIG. 2, and thus description thereof will be omitted.

The disk device 402 of the management server 103 stores various types of files, including applications 412 to be read by a CPU 401, a database 413, and the OS (not illustrated). The applications 412 also perform processing for ordering consumables on an automatic consumables ordering system to be described below and processing for registering a user and a printer with a Web service.

### <Sequence>

Processing from the start of setup of the printer 102 through registration with the Web service to the completion of setup of the printer 102 will now be described.

The Web service in the present exemplary embodiment is, for example, a flat-sum Web service in which the printer 102 is chartered to a user and the user can get replacement consumables on a flat-sum basis together with a charge for using the printer main body, and the following is a description using this example.

The present Web service uses the automatic consumables ordering system in which the printer 102 notifies the management server 103 of remaining amounts of consumables, such as a recording agent and a sheet, and the management server 103 automatically orders a consumable item from a supplier office based on information on the remaining amount of the consumable item. In this Web service, use of printer functions, such as printing and scanning, involves registration with the Web service. No user can start using the printer 102 without Web service registration.

In addition, the printer 102 periodically communicates with the management server 103 to notify of remaining amounts of consumables, such as a recording agent and a sheet. The management server 103 performs automatic ordering of consumables, issues a function stop instruction to the printer 102 when the upper limit of use is reached, charges the user an additional charge, and performs other processing in accordance with arrangement contents at the time of Web service registration. When periodic communication between the printer 102 and the management server 103 is not performed due to, for example, disconnection of the printer 102 from the network, the function of the printer 102 may be stopped to prevent unauthorized use.

An example of processing from the start of setup through registration with the Web service to completion of setup of the printer 102 will now be described in detail.

In the following description, the PC 101 is connected to the printer 102 via the USB cable 105, and is in a communicable state with the printer 102. It is premised that the printer 102 is connected to the PC 101 via the cable 105, but is not connected to the Internet via the access point 104.

It is also premised that acquisition and installation of a printer driver, network connection processing of a printer, and registration processing with a Web service according to the present exemplary embodiment are performed by a setup application among the applications 212 stored in the disk device 202 of the PC 101.

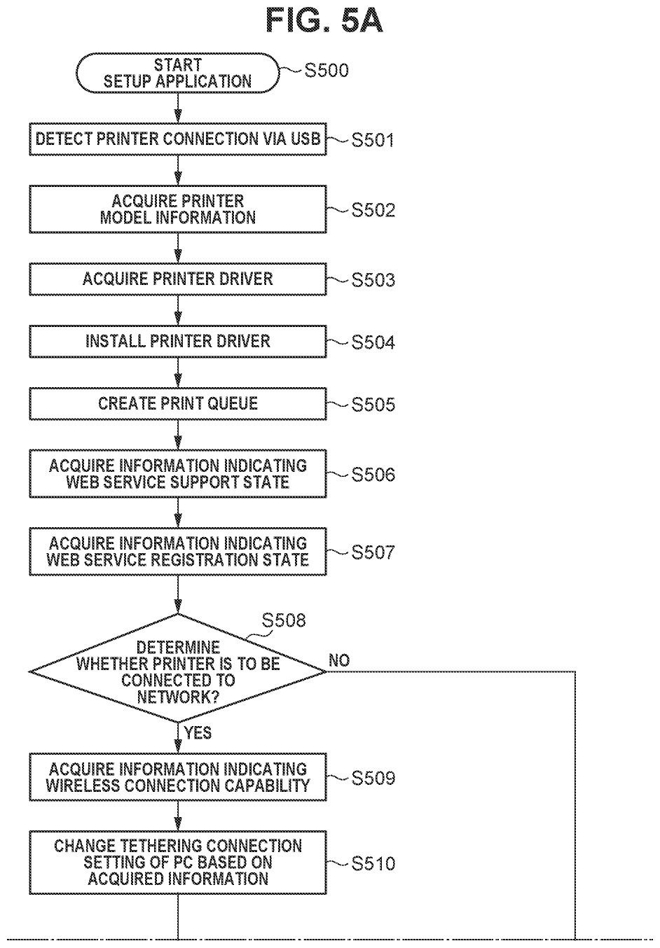

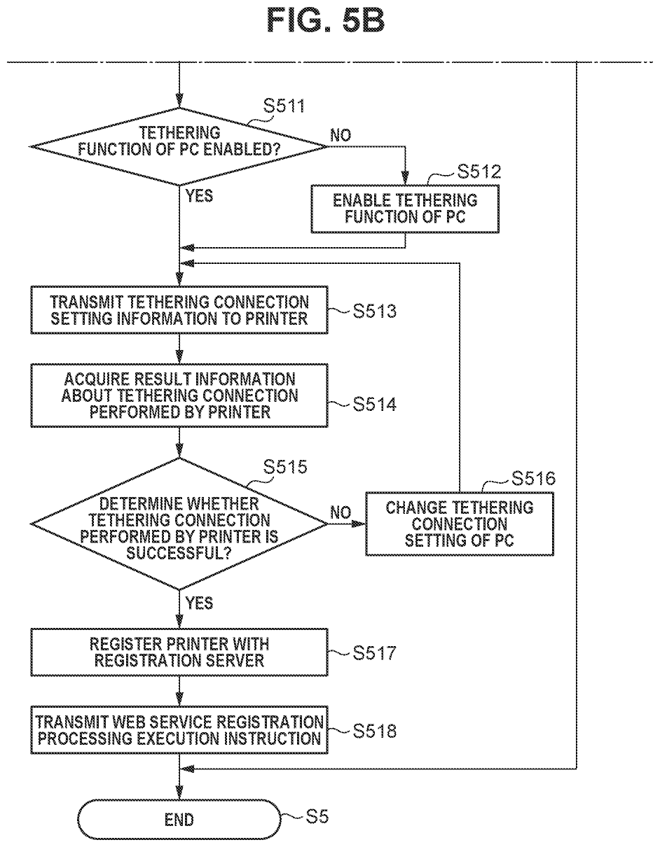

FIG. 5 is a flowchart illustrating an example of processing of the setup application according to the first exemplary embodiment. The processing illustrated in this flowchart is performed by the CPU 201 in the PC 101 loading the setup application included in the applications 212 stored in the disk device 202 into the memory 204 and running the setup application.

First, as the CPU 201 in the PC 101 loads the setup application included in the applications 212 stored in the disk device 202 into the memory 204 and runs the setup application, a predetermined screen is displayed on the display unit 205 by the setup application. In step S500, as the user gives a predetermined instruction, for example, by pressing a button for starting processing for setup on the predetermined screen, the setup application being run by the CPU 201 in the PC 101 starts processing for setup of the printer 102. In the following description, the setup application run by the CPU 201 in the PC 101 will be described as a main processor for the processing.

In step S501, the setup application detects connection of the printer 102 via the USB cable 105.

In step S502, the setup application communicates with the printer 102 via the USB cable 105 to acquire model information on the printer 102. It is premised herein that the model information on the printer 102 is stored in advance in the program memory 306 of the printer 102 or another storage.

In step S503, the setup application acquires an appropriate printer driver based on the model information on the printer 102 acquired in step S502. Examples of a method of acquiring the printer driver include a method of downloading a printer driver having the same model information from a Web server via the Internet, and a method of acquiring a printer driver having the same model information from one or a plurality of printer drivers included in the setup application or the OS.

In step S504, the setup application installs the printer driver acquired in step S503 into the PC 101.

In step S505, the setup application creates a print queue associated with the printer driver. The print queue created here is a print queue associated with the USB port detected in step S502. The PC 101 is able to transmit, via the created print queue, image data and a print instruction to the printer 102 connected via the USB cable 105 to the PC 101.

If the appropriate printer driver has been installed into the printer 102 and the print queue associated with the appropriate printer driver has been created in advance, the setup application may skip these pieces of processing.

In step S506, the setup application communicates with the printer 102 via the USB cable 105 to acquire information indicating a Web service support state of the printer 102. It is premised that the information indicating the Web service support state acquired here is stored in advance in, for example, the program memory 306 of the printer 102.

In step S507, the setup application acquires from the printer 102 a registration state of the Web service acquired in step S506 that the printer 102 supports. The registration state acquired here indicates whether the Web service is available for the printer 102. As an example, states, such as “preparing for service use”, “service available state”, and “service unavailable state” are conceivable. It is premised that the registration state of the Web service is stored in advance in the program memory 306 of the printer 102. After the registration processing on the Web service is performed by the management server 103 and the registration state of the Web service is then changed, the printer 102 can acquire a registration state change notification from the management server 103 and rewrite the registration state stored in the program memory 306.

In step S508, the setup application determines whether the printer 102 is to be connected to the network based on the Web service support state and the Web service registration state acquired in steps S506 and S507, respectively. Specifically, the setup application determines whether the Web service determined to be supported by the printer 102 in step S506 is a Web service necessary for use of the printer 102. If it is determined to be “necessary” and the Web service registration state acquired in step S507 is “unregistered state”, the setup application determines that the printer 102 is to be connected to the network. On the other hand, in step S506, if it is determined that there is no Web service supported by the printer 102, in step S508, if it is determined that the Web service supported by the printer 102 is unnecessary for use of the printer 102, or in step S507, if it is determined that the printer 102 is “registered” with the Web service, the setup application determines that network connection for setup of the printer 102 is unnecessary. If the supported Web service requires network connection of the printer 102 for use of the printer 102, the setup application may determine that network connection of the printer 102 is necessary even with the printer 102 “registered” with the Web service.

In step S508, if it is determined that network connection of the printer 102 is unnecessary (NO in step S508), the setup application advances the processing to step S519. In step S519, the setup application determines that the processing for use of the printer has ended, and the processing of this flowchart then ends.

On the other hand, in step S508, if it is determined that network connection of the printer 102 is necessary (YES in step S508), the setup application advances the processing to step S509.

In step S509, the setup application communicates with the printer 102 via the USB cable 105 to acquire information indicating the wireless connection capability of the printer 102. This information includes information on a wireless connection interface to which the printer 102 is connectable. Examples of the wireless connection interface information include a frequency band of, channel information on, and an encryption scheme for a wireless LAN to which the printer 102 is connectable. It is premised that the acquired information indicating the wireless connection capability of the printer 102 is stored in advance in, for example, the program memory 306 of the printer 102.

In step S510, the setup application changes the tethering connection setting of the PC 101 in the information indicating the wireless connection capability acquired in step S509 to a connection setting where the printer 102 is connectable. For example, if the acquired information indicating the wireless connection capability includes a frequency band where the printer 102 is connectable, and the value thereof is only the 2.4-gigahertz (GHz) band, the value of the item indicating the wireless LAN frequency band in the tethering connection setting of the PC 101 is changed to the 2.4-GHz band. In addition, if information indicating another wireless connection capability, such as wireless LAN channel information and an encryption scheme, is acquired, the value of the item corresponding to the tethering connection setting of the of the PC 101 is changed in the same manner. Changeable tethering connection settings may vary depending on the OS installed into the PC 101. The processing of changing the tethering connection setting may be performed by a user operation, such as by the setup application calling an OS setting screen (not illustrated) related to the tethering connection setting and the user pressing a button on the screen. The changed tethering connection setting is stored in the tethering connection setting information 213 by the OS of the PC 101. Thus, changing the tethering connection setting of the PC 101 to a setting where the printer 102 is connectable allows reduction of the possibility for the printer 102 to fail in performing the tethering connection processing, which will be described below.

In step S511, the setup application determines whether the tethering connection function of the PC 101 is enabled. If it is determined that the tethering connection function of the PC 101 is not enabled (is disabled) (NO in step S511), the setup application advances the processing to step S512. In step S512, the setup application changes the tethering connection function of the PC 101 to the enabled state. The processing of enabling the tethering connection function may be changed by a user operation, such as by the setup application calling an OS setting screen (not illustrated) related to the tethering connection function and the user pressing a button on the screen. After the processing in step S512 is performed, the setup application advances the processing to step S513.

On the other hand, in step S511, if it is determined that the tethering connection function of the PC 101 is enabled (YES in step S511), the setup application advances the processing to step S513.

In step S513, the setup application sends the tethering connection setting information 213 on the PC 101 via the USB cable 105 to the printer 102. In response to this, the printer 102 attempts a tethering connection to the PC 101 using the identification information (e.g., SSID) and authentication information (e.g., password) for tethering connection included in the acquired tethering connection setting information 213. Next, the printer 102 transmits information about a result of the tethering connection via the USB cable 105 to the printer 102.

In step S514, the setup application communicates with the printer 102 via the USB cable 105 to acquire the tethering connection result information on the printer 102.

In step S515, the setup application determines whether the printer 102 has succeeded in the tethering connection from the tethering connection result information on the printer 102 acquired in step S514. If it is determined that the printer 102 has failed in the tethering connection (NO in step S515), the setup application advances the processing to step S516.

In step S516, the setup application changes the tethering connection setting of the PC 101. In changing the tethering connection setting, the setup application performs change processing to change the setting information to other setting information different from the tethering connection setting information changed in step S510 while the other setting information matches the information indicating the wireless connection capability of the printer 102 acquired in step S509. For example, if the frequency band of the wireless LAN in the tethering connection setting information is changed to the 5-GHz band in step S510 from between the 2.4-GHz band and the 5-GHz band as the frequencies of the wireless LANs supported by the printer 102, in step S516, the frequency band of the wireless LAN in the tethering connection setting information may be changed to the 2.4 GHz band. Further, Wi-Fi® tethering (tethering based on a wireless LAN connection scheme) may be changed to Bluetooth® tethering (tethering based on a Bluetooth® connection scheme), and vice versa. After changing the tethering connection setting information on the PC 101 in step S516, the setup application returns the processing to step S513.

On the other hand, in step S515, if it is determined that the printer 102 has succeeded in the tethering connection (YES in step S515), the setup application advances the processing to step S517.

In step S517, the setup application performs registration processing for registering the printer 102 with the management server 103. Specifically, the setup application communicates with the management server 103, and transmits identification information on the printer 102, such as its serial number. Further, identification information on the printer 102 may be acquired in step S502 or at this timing. The identification information on the printer 102 is recorded in the database 413 of the management server 103, and the printer 102 becomes ready for Web service registration. Depending on the type of the Web service, additional information necessary for use of the Web service, such as the address and information on a credit card of the user, is also recorded in the database 413 in a state associated with the identification state of the printer 102. An input of such additional information may be made in procurement of a printer or after the processing of the setup application according to the present exemplary embodiment is completed. The registration processing performed by the management server 103 may be performed by the management server 103 alone, or may be performed by an entire system including a plurality of servers.

In step S518, the setup application transmits an execution instruction of Web service registration processing to the printer 102 via the USB cable 105. After acquiring the execution instruction of Web service registration processing, the printer 102 communicates with the management server 103 and transmits information for the Web service registration of the printer 102 including information on identification of the printer 102, such as its serial number. The management server 103 collates the identification information acquired from the printer 102 with the identification information recorded in the database 413. If a match between these pieces of the identification information is registered, the management server 103 transmits information including a start instruction of the Web service to the printer 102. This information may include arrangement information for the Web service to be started. After acquiring the information including the Web service start instruction from the management server 103, the printer 102 enters a Web service available state.

A series of processing from the start of setup of the printer 102 through the registration with the Web service to the completion of the setup of the printer 102 has been described above. According to the present exemplary embodiment, even if a setup application is run with a PC and a printer USB-connected to each other, setup processing including registration processing for a Web service for the printer can be performed via network connection of the PC in a simplified manner. Consequently, even in a form in which a PC and a printer are USB-connected for use, the printer can be used under no restriction in use of the printer due to the printer being unregistered with a Web service.

A second exemplary embodiment will be described. In the first exemplary embodiment, the PC 101 and the printer 102 are USB-connected to each other. In the present exemplary embodiment, a case in which the PC 101 and the printer 102 are connected by Wi-Fi® Direct (hereinafter, this connection is referred to as “Direct connection”) will be described as an example. The Direct connection allows the PC 101 and the printer 102 to establish connection by performing Wi-Fi® communication without relay by an access point, for example. Like numbers refer to like components and pieces of processing as those in the first exemplary embodiment, and description thereof will be omitted.

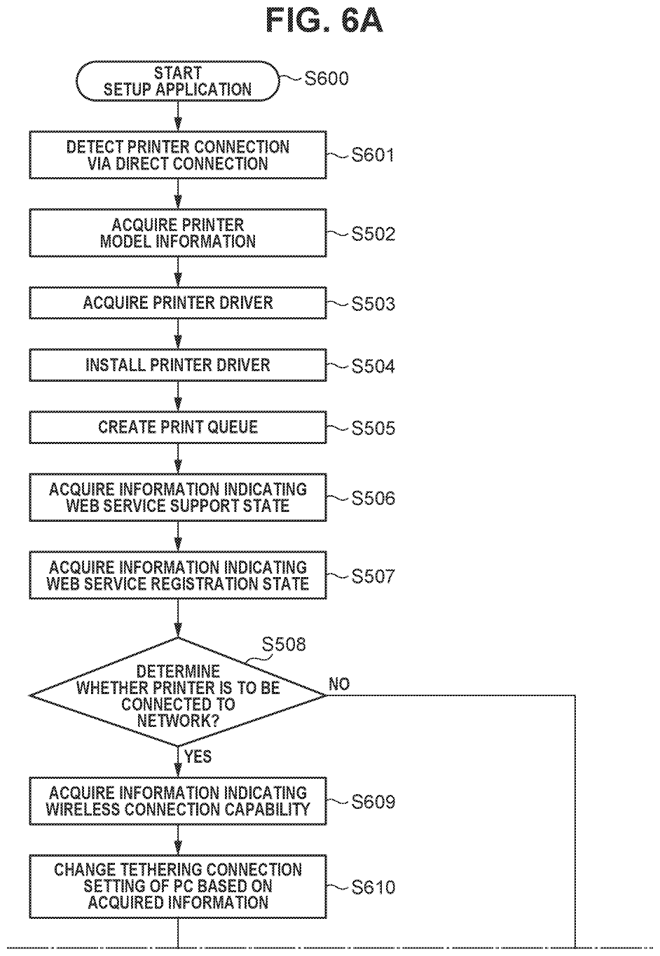

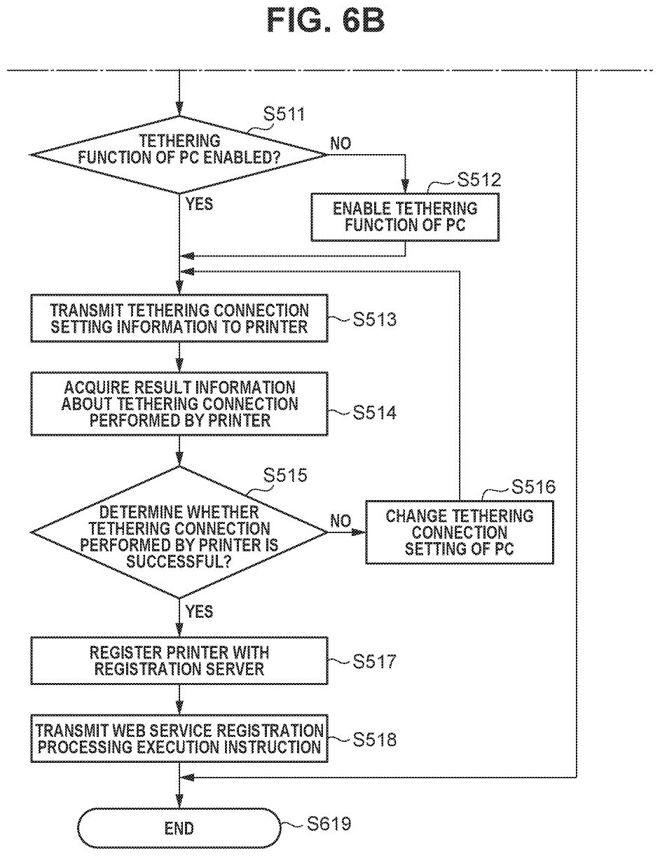

FIG. 6 is a flowchart illustrating an example of processing of a setup application according to the second exemplary embodiment. The processing illustrated in this flowchart is carried out by the CPU 201 in the PC 101 loading the setup application included in the applications 212 stored in the disk device 202 into the memory 204 and running the setup application. The same pieces of processing as those in FIG. 5 are denoted by the same step numbers, and description thereof will be omitted.

As in the first exemplary embodiment illustrated in FIG. 5, as a user gives a predetermined instruction on a predetermined screen, in step S600, the setup application starts processing for setup of the printer 102. In the following description, the setup application run by the CPU 201 in the PC 101 will be described as a main processor for the processing.

In step S601, the setup application detects the Direct connection of the printer 102. Specifically, first, the setup application acquires from the OS information including IP addresses of devices to which the PC 101 is wirelessly connected. Next, the setup application performs communication with the acquired IP addresses of the connected devices, and determines whether specific identification information indicating a printer in the Direct connection state can be acquired. If specific identification information can be acquired, it is determined that the Direct connection with a device having the identification information is detected.

Steps S502 to S508 are the same as the processing illustrated in FIG. 5, and thus description thereof will be omitted.

In the present exemplary embodiment, in step S508, if it is determined that network connection of the printer 102 is necessary (YES in step S508), the setup application advances the processing to step S609.

In step S609, the setup application communicates with the printer 102 via the Direct connection and acquires information indicating the wireless connection capability of the printer 102. This information includes information on a wireless connection interface to which the printer 102 is connectable.

In step S610, the setup application changes a tethering connection setting of the PC 101 in the information indicating the wireless connection capability acquired in step S609 to a connectable wireless connection setting while maintaining the Direct connection with the printer 102. For example, the wireless connection interface for the tethering connection setting may be Bluetooth® Low Energy, or another wireless connection interface different from the wireless connection interface for the Direct connection with the printer 102.

Thereafter, the setup application sequentially performs the processing from steps S511 to S518 described in the first exemplary embodiment, and completes registration of the printer 102 with the Web service and setup of the printer 102.

In the second exemplary embodiment, a form in which the PC 101 and the printer 102 transmit and receive information through communication via the Direct connection is described. However, the PC 101 and the printer 102 may be peer-to-peer (P2P) —connected using another wireless connection scheme that allows communication only between two devices, such as connection using Bluetooth® Low Energy.

Consequently, according to the second exemplary embodiment, even if a setup application is run with a PC and a printer in the Direct connection to each other, setup processing including registration processing for a Web service for the printer can be performed via network connection of the PC in a simplified manner.

In both the first and second exemplary embodiments, after the processing in step S518, the setup application may acquire an execution result of the Web service registration processing from the printer 102 via the USB cable 105, and determine whether the printer 102 has succeeded in the Web service registration processing. If the printer 102 has succeeded in the Web service registration processing, the setup application may disconnect the tethering connection with the printer 102. However, if the supported Web service requires a network connection for use of the printer 102, it is also suitable that the tethering connection with the printer 102 is not to be disconnected.

On the other hand, if the printer 102 has failed in the Web service registration processing, the setup application may display information indicating that the printer 102 has failed in the Web service registration processing on the display unit 205 to notify the user of the information.

In each of the exemplary embodiments described above, a configuration has been described in which the PC 101 causes an image processing apparatus, such as the printer 102, to be connected to the PC 101 by tethering, to be connected to a network, and to be registered with a Web service. However, a device to be connected to the PC 101 by tethering is not limited to an image processing apparatus, such as the printer 102. For example, a scanner or a smart home appliance having a wireless connection function may be used, and any device (communication device) having a wireless connection function may be used. In other words, a configuration may be used in which an information processing apparatus, such as a PC, a tablet terminal, or a smartphone, is communicably connected to a communication apparatus as described above, acquires the wireless connection capability of the communication apparatus from the communication apparatus, changes a tethering connection setting of the information processing apparatus so as to match the wireless connection capability, changes the tethering connection function to an enabled state if the tethering connection function is disabled, and transmits information including the tethering connection setting to the communication apparatus, and the communication apparatus performs tethering connection to the information processing apparatus based on the information including the tethering connection setting transmitted from the information processing apparatus.

Further, the processing of FIGS. 5A and 5B or 6A and 6B may be performed each time the PC 101 is connected to the printer 102. This allows the printer 102 to be used through establishment of connection to a network each time the printer 102 is used from the PC 101.

As described above, setup processing including network connection can be performed in a simplified manner, regardless of the wireless connection capability of a communication device. This allows a communication apparatus to be connected to a network to be registered with a Web service even without an access point nearby to which the communication apparatus is connectable. Consequently, setup processing for a printer on the premise of network connection and registration of a specific Web service can be performed in a simplified manner, regardless of the wireless connection capability of the printer.

The configurations and contents of the various types of data described above are not limited thereto, and it goes without saying that various configurations and contents of data may be used in accordance with applications and purposes.

Although examples have been described as exemplary embodiments, the present disclosure can be embodied as, for example, a system, an apparatus, a method, a program, or a storage medium. Specifically, the present disclosure may be applied to a system including a plurality of devices, or an apparatus constituting a single device.

All configurations obtained by combining the foregoing exemplary embodiments are also included in the present disclosure.

### Other Embodiments

Some embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2022-151312, which was filed on Sep. 22, 2022 and which is hereby incorporated by reference herein in its entirety.

What is claimed is:

1. A non-transitory computer-readable storage medium storing computer-executable instructions that, when executed by a computer of an information processing apparatus, cause the computer of the information processing apparatus to perform operations that include:
communicably connecting to a communication apparatus;
acquiring a wireless connection capability of the communication apparatus from the communication apparatus as a first acquisition;
changing a setting for tethering connection of the information processing apparatus so as to match the wireless connection capability as a first setting; and
transmitting information including the setting for tethering connection to the communication apparatus.

2. The non-transitory computer-readable storage medium according to claim 1, wherein the communication apparatus performs the tethering connection to the information processing apparatus based on the information including the setting for tethering connection transmitted from the information processing apparatus.

3. The non-transitory computer-readable storage medium according to claim 1, wherein the operations further include acquiring a connection result of the tethering connection performed by the communication apparatus from the communication apparatus based on the information including the setting for tethering connection transmitted in the transmitting as a second acquisition,
wherein in the first setting, in a case where the connection result acquired in the second acquisition indicates a connection failure, the setting for tethering connection is changed to a setting that matches the wireless connection capability and is different from a setting corresponding to the connection failure, and
wherein in the transmitting, information including the changed setting for tethering connection is transmitted to the communication apparatus.

4. The non-transitory computer-readable storage medium according to claim 1, wherein the operations further include changing, in a case where a function of the tethering connection is in a disabled state, the function of the tethering connection to an enabled state as a second setting.

5. The non-transitory computer-readable storage medium according to claim 1, wherein the operations further include acquiring a support state of a Web service for the communication apparatus and a registration state of the Web service for the communication apparatus after connection in the connecting as a third acquisition,
wherein execution of changing the setting for tethering connection in the first setting and transmitting the information including the setting for tethering connection in the transmitting is controlled based on content acquired in the third acquisition.

6. The non-transitory computer-readable storage medium according to claim 5, wherein the operations further include:
acquiring, from the communication apparatus, an execution result of specific processing for using the Web service performed in a case where the tethering connection performed by the communication apparatus is successful as a fourth acquisition; and
changing, in a case where the execution result acquired in the fourth acquisition indicates a success, a function of the tethering connection to a disabled state as a third setting.

7. The non-transitory computer-readable storage medium according to claim 1, wherein in the first setting, a frequency band of a wireless local area network (LAN) for the tethering connection is changed.

8. The non-transitory computer-readable storage medium according to claim 1, wherein in the first setting, an encryption scheme for a wireless LAN of the tethering connection is changed.

9. The non-transitory computer-readable storage medium according to claim 1, wherein in the first setting, a wireless connection method for the tethering connection is changed to a wireless LAN connection method or a Bluetooth® connection method.

10. The non-transitory computer-readable storage medium according to claim 1, wherein, in the connecting, the communication apparatus is connected by Universal Serial Bus (USB) connection.

11. The non-transitory computer-readable storage medium according to claim 1, wherein, in the connecting, the communication apparatus is connected by wireless connection without a relay.

12. An information processing apparatus comprising:
a connection unit configured to communicably connect to a communication apparatus;
one or more memories; and
one or more processors, wherein the one or more processors and the one or more memories are configured to cause the information processing apparatus to:
acquire a wireless connection capability of the communication apparatus from the communication apparatus;
change a setting for tethering connection of the information processing apparatus so as to match the wireless connection capability; and
transmit information including the setting for tethering connection to the communication apparatus.

13. A control method for an information processing apparatus, the control method comprising:
communicably connecting to a communication apparatus;
acquiring a wireless connection capability of the communication apparatus from the communication apparatus;
changing a setting for tethering connection of the information processing apparatus so as to match the wireless connection capability as a setting; and
transmitting information including the setting for tethering connection to the communication apparatus.
